(19) United States
(12) Patent Application Publication
(10) Pub. No.: US 2010/0103900 A1
(43) Pub. Date: Apr. 29, 2010

(54) BEAMFORMING METHOD AND DEVICE

(76) Inventors: Choong-Il Yeh, Daejeon (KR); Dong-Seung Kwon, Daejeon (KR); Jee-Hwan Ahn, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/518,233

(22) PCT Filed: Sep. 19, 2007
(86) PCT No.: PCT/KR07/04555

§ 371 Date: Jun. 8, 2009

(30) Foreign Application Priority Data
Dec. 8, 2006 (KR) 10-2006-0124895

(51) Int. Cl. H04W 4/00

(52) U.S. Cl. 370/330; 375/267

(57) ABSTRACT

The present invention relates to a beamforming device in an orthogonal frequency division multiplexing access system, and a method thereof. In the method, a switched beamforming algorithm is applied to perform downlink beamforming, and an adaptive beamforming algorithm is applied to perform uplink receiving beamforming. In addition, a half wavelength array antenna is used to simultaneously allocate the same resource to two terminals separately positioned in two different spaces, so as to support spatial division multiple access (SDMA). In this case, since a base station uses channel status information at transmitter (CSIT) for transmitting beamforming and receiving beamforming, the SDMA may be supported without obtaining additional channel status information at receiver (CSIR) when realizing the uplink receiving beamforming.

### TECHNICAL FIELD

The present invention relates to a beamforming device in an orthogonal frequency division multiple access (OFDMA) system and a method thereof, and more particularly to a beamforming device for simultaneously obtaining spatial division multiple access (SDMA) and multi-user diversity (MUD) gains, and a method thereof.

### BACKGROUND ART

Since a plurality of narrowband subcarriers are transmitted to transmit wideband information in an orthogonal frequency division multiplexing (OFDM) method, the OFDM method has high robustness against inter-symbol interference (ISI) and simple channel estimation and compensation. Accordingly, the OFDM method is used to provide a system for providing a wireless wideband data service. Particularly, a system including various terminals using the OFDM method to share subcarriers in uplink or downlink is referred to as an orthogonal frequency division multiple access (OFDMA) system.

To increase system performance, a beamforming (BF) method using multiple antennas is used in the OFDMA system.

In the BF method, antennas are disposed at predetermined intervals, and the same signals are transmitted by being multiplied by weighting vectors for each antenna. In addition, interference to a mobile terminal positioned in a direction that is different from a direction in which a beam is heading is reduced, and an average signal to interference plus noise ratio (SINR) in a desired mobile terminal is increased with the same power.

The BF method is classified as a switched BF algorithm and an adaptive BF algorithm according to an algorithm determining a weighting vector. In the switched BF algorithm, weighting vectors for several directions are established and are selectively used. In the adaptive BF algorithm, a weighting vector that is appropriate for a predetermined channel environment is selected, and the selected weighting vector is instantaneously applied.

It is not difficult to estimate the weight vector in a receiving BF method since a pilot inserted into a data packet is used to establish the weighting vector in the adaptive BF algorithm, but a transmitting BF algorithm is difficult to apply to an actual system since it is required to feed back channel state information at transmitter (CSIT) to establish the weighting vector in the adaptive BF algorithm.

That is, since bandwidth used to perform a feedback operation is not less in obtaining the CSIT in the transmitting BF method and a measurement result error caused by a feedback delay causes the performance to be degraded, the switched BF algorithm is used as the transmitting BF and the adaptive BF algorithm is used as the received BF in a system. Conventionally, since the CSIT is obtained after all terminals enter a network and there is no method for obtaining the CSIT for a corresponding terminal by a base station before entrance of the terminal, it is required to improve detection performance for a packet transmitted by the terminal before the entrance to the network.

In addition to the problem in obtaining the CSIT, since a beam formed in the adaptive BF algorithm transmits power in various directions when a spatial division multiple access (SDMA) is realized in a transmitter, users receiving the same frequency resources have various interferences. In addition, since there is no power transmission in the received BF, it is not required to consider the interference, and it is required to select the adaptive BF method.

Further, when the receiving beamforming is performed in a predetermined direction while assuming that a waveform received in an array antenna is a plane waveform, beam patterns formed according to intervals between antennas are different. A four wavelength antenna is efficient when it is required to transmit the power to a receiver in various directions, but it is inappropriate when it is required to provide the SDMA to users in different places by using a directional beam, since beams evenly formed in all directions transmit respective transmission power to each other through multipaths and cause interference.

However, a signal is received or transmitted in a desired direction to improve a received signal to noise ratio (SNR) and improve performance when array antennas formed with a half wavelength interval are used, and interference to the users in different places is reduced when the signal is transmitted in the desired direction. In addition, since interference by unwanted user signals is reduced when the signal is received from a desired direction, frequency usage efficiency may be increased by the SDMA simultaneously reusing frequency resources.

Further, a system using the OFDM transmission method performs a band selection scheduling operation by using preferred band information included in the CSIT and obtains a multi-user diversity (MUD) gain. However, since a preferred band changes as time passes, it is difficult to apply the preferred band in a high speed mobile environment due to a feedback delay. In addition, it is difficult to simultaneously obtain the SDMA gain and the MUD gain in the high speed mobile environment.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide downlink transmission beamforming and uplink receiving beamforming methods for simultaneously obtaining spatial division multiple access and multi-user diversity (MUD) gains. In addition, the present invention has been made in an effort to provide a device for improving detection performance for a packet transmitted by a terminal to enter a network, and a method thereof.

### Technical Solution

An exemplary beamforming device according to an embodiment of the present invention detects a packet transmitted by a terminal before entering a network to enter the network. The exemplary beamforming device includes at least one receiving antenna, a data acquisition unit, a weighting vector applying unit, and a detection unit. The at least one receiving antenna receives a signal from the terminal. The data acquisition unit obtains and outputs the signal received through the at least one receiving antenna. The weighting vector applying unit sequentially applies at least one weighing vector to the received signal and outputting the signal. The detection unit the signal output from the weighting vector applying unit for each the weighting vector.

In an exemplary beamforming method of a base station to detect packets transmitted by a plurality of terminals to enter a network, a signal including packets transmitted from the terminals is received, the respective packets one-by-one by sequentially applying weighting vectors belonging to the base station is detected.

In an exemplary uplink receiving beamforming method of a base station in a frequency division duplex (FDD) wireless communication system, transmission channel information measured by a terminal is received, the terminal is grouped according to a preferred switched beam index included in the transmission channel information, spatial division multiple access corresponding to the terminals grouped, and a signal received is obtained from the terminal according to the spatial division multiple access through an adaptive beamforming algorithm.

### BRIEF DESCRIPTION OF THE DRAWINGS

FIG. 1 is a diagram of a configuration of an uplink receiving blind beamforming device according to an exemplary embodiment of the present invention.

FIG. 2 is a diagram representing a downlink transmission beamforming method of a base station according to the exemplary embodiment of the present invention.

FIG. 3 is a flowchart representing an uplink receiving beamforming method of the base station after a terminal enters a network in the exemplary embodiment of the present invention.

FIG. 4 is a flowchart representing an uplink receiving blind beamforming process according to the exemplary embodiment of the present invention.

### MODE FOR THE INVENTION

In the following detailed description, only certain exemplary embodiments of the present invention have been shown and described, simply by way of illustration. Accordingly, the drawings and description are to be regarded as illustrative in nature and not restrictive. Like reference numerals designate like elements throughout the specification.

In addition, unless explicitly described to the contrary, the word comprise and variations such as “comprises” or “comprising” will be understood to imply the inclusion of stated elements but not the exclusion of any other elements.

A beamforming device according to an exemplary embodiment of the present invention and a method thereof will be described with reference to the figures.

A configuration of an antenna according to the exemplary embodiment of the present invention will be firstly described before the beamforming device and the method thereof are described. A receiving mobile terminal includes receiving antennas or multiple antennas formed at wide intervals, and a single transmitting antenna. A base station uses a half wavelength array antenna as a transmitting/receiving antenna, which will be described later.

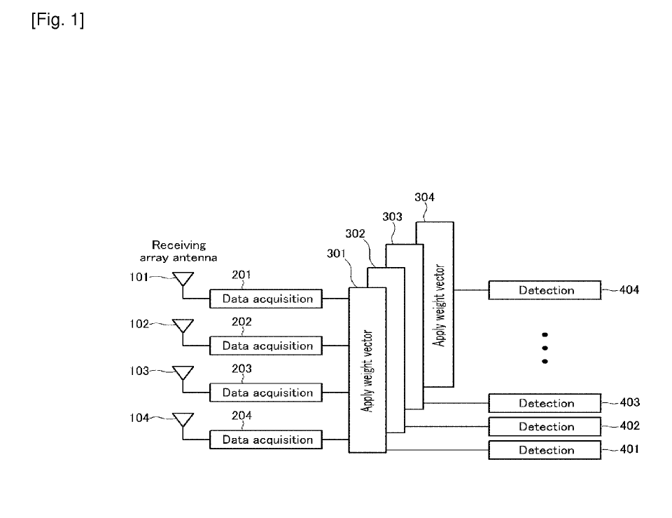

FIG. 1 is a diagram of a configuration of an uplink receiving blind beamforming device according to the exemplary embodiment of the present invention. The blind beamforming device is used to detect a packet transmitted by a random access method in a process for trying to enter a network before a terminal enters the network, and the blind beamforming device is included in a base station system.

Referring to FIG. 1, the blind beamforming device includes data acquisition units 201, 202, 203, and 204, weighting vector applying units 301, 302, 303, and 304, and detection units 401, 402, 403, and 404.

The data acquisition units 201, 202, 203, 204 acquire, store, and output signals received by receiving antennas 101, 102, 103, and 104.

The weighting vector applying units 301, 302, 303, and 304 sequentially apply weighting vectors directed in a predetermined direction to the signals output from the data acquisition units 201, 202, 203, and 204.

The detection units 401, 402, 403, and 404 independently detect the signals output from the weighting vector apply units 301, 302, 303, and 304 for the respective weighting vectors.

A beamforming method performed by a base station according to the exemplary embodiment of the present invention will be described with reference to the figures.

Before describing the beamforming method, a band selection scheduling method of an orthogonal frequency division multiplexing (OFDM) transmission method to obtain a multi-user diversity (MUD) gain will be described.

In the OFDM transmission method, a plurality of subcarriers are used, and effects of channels applied to the respective subcarriers are not the same. However, since effects of channels applied to the neighboring subcarriers are similar, the channels may be grouped. In this case, an OFDM channel may include a plurality of bands, and the effects of channels for each band are different. The effect of a channel applied to a predetermined band in a multi-user environment varies according to a users environment. A band may cause a deep fading effect to a user, but the band may have a great channel condition for another user. Accordingly, when a base station performs a band scheduling operation knowing preferred band information, the base station may obtain a multi-user diversity (MUD) gain.

In a high speed mobile terminal, since the preferred band continuously varies as a channel varies, it is difficult to perform the band selection scheduling operation due to a feedback delay. In addition, since the preferred band and the beam index may not correspond to each other in a high speed mobile environment, it is difficult to simultaneously obtain the multiple MUD gain and a spatial division multiple access (SDMA) gain through the band selection scheduling operation.

Accordingly, different downlink resource allocation methods are respectively applied to a high speed mobile terminal and a low speed mobile terminal, which are given in Table 1.

TABLE 1

| | Low speed terminal | High speed terminal |
|---|---|---|
| Directional switched BF | ◯ | X |
| (Localized mode) | | |
| Directional switched BF | X | ◯ |
| (Distributed mode) | | |
| DL transmission SDMA | ◯ | X |
| (Localized mode) | | |

| | |
|---|---|
| DL transmission SDMA | ◯ |
| (Distributed mode) | |

In Table 1, a localized mode denotes a mode for performing a resource allocation operation by performing the band selection scheduling operation, and a distributed mode is a mode for applying a subcarrier selection method using frequency diversity without performing the band selection scheduling operation.

A downlink transmission beamforming method will now be described with reference to Table 1 and figures.

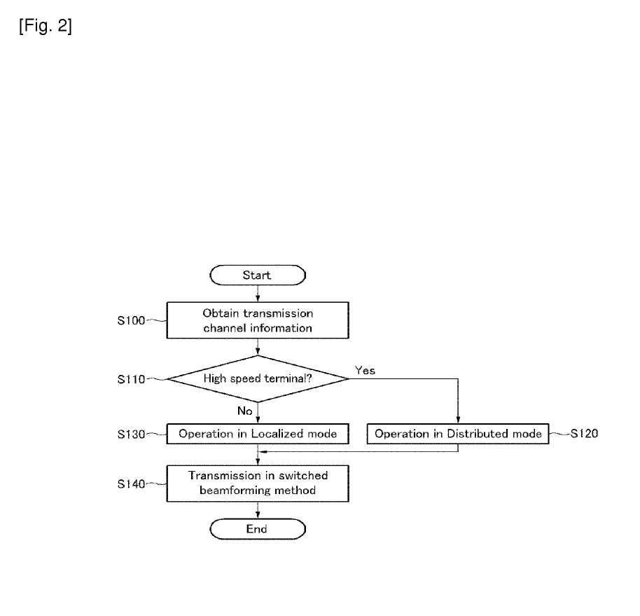

FIG. 2 is a diagram representing the downlink transmission beamforming method of the base station to obtain the SDMA and MUD gains according to the exemplary embodiment of the present invention.

Here, in the downlink transmission beamforming method, a switched beamforming (BF) algorithm is used to perform a beamforming operation. Channel status information at transmit (CSIT) is obtained from a mobile terminal to perform the downlink transmission beamforming operation for the mobile terminal in step S100. The CSIT includes a preferred switched beam index, a band index, and a channel quality indicator (CQI), and the CSIT may be obtained by one among uplink sounding, a downlink preamble, and a downlink preamble to which the beamforming operation is applied.

In the uplink sounding, a terminal transmits a training signal to a base station by using allocated uplink resources. The base station uses the training signal to measure uplink CSI and compensate a characteristic difference of radio frequency (RF) paths of a receiver, and uses a reversible channel characteristic to obtain downlink CSI (here, the downlink CSI is the CSIT) when a time division duplex (TDD) method in which a reversible channel is available is used.

When the downlink preamble is used, the terminal transmits the downlink preamble that is capable of measuring the downlink channel for each physical transmitting antenna, measures the downlink channel (here, the downlink CSI measured by the terminal is the CSIT at the base station), and reports it to the base station.

When the downlink preamble to which the BF is applied is used, the base station transmits the downlink preamble to which the BF is applied, and the terminal uses it to measure the downlink channel and reports the downlink channel to the base station. The downlink preamble method to which the BF is applied is efficiently used in the switched BF algorithm in which the number of valid antennas is limited. In this case, formed beams instead of physical antennas may be considered as valid antennas. That is, when four transmitting antennas form six beams, the number of valid antennas is six.

When the base station obtains the CSIT of the terminal as described above, the base station determines in step S110 whether the terminal moves at a high speed or at a low speed, and the base station operates in a distributed mode in which the band selection scheduling is not performed when the terminal moves at a high speed, in step S120.

When the terminal does not move at a high speed, the base station uses the preferred band index included in the CSIT to perform resource allocation in a localized mode in step S130.

When the downlink resource allocation is finished, the base station uses the preferred switched beam index that is included in the CSIT that is transmitted as feedback information from the terminal, generates a directional beam so as to realize the SDMA, and transmits the directional beam to the terminal in step S140. In this case, the base station uses a half wavelength array antenna to provide the directional beam to the terminal. The half wavelength array is used to perform the downlink transmission beamforming since the width of beam is wide and performance is not considerably deteriorated in a high speed mobile environment. Differing from a four wavelength array antenna in which the preferred switched beam index is frequently updated when the width of beam is narrow, performance of the half wavelength array antenna is not rapidly deteriorated when an update period is increased since the half wavelength array antenna has a wide beam.

In addition, when the band selection scheduling operation is differently performed in the high speed mobile environment and the low speed mobile environment, the MUD gain for the low speed mobile environment may be obtained without considerable performance deterioration.

When the downlink transmission beamforming operation is performed by using the switched BF method, the amount of required CSIT information is reduced, it is easy to perform the downlink transmission beamforming operation, and interference may be reduced when the SDMA is applied in the multi-user environment. In addition, when the half wavelength array antenna is used, it may be applied in the high speed mobile environment without considerable performance deterioration since the width of beam is wide. That is, since the width of beam is wide when the half wavelength array antenna is used, the performance is not rapidly deteriorated when the update period is increased.

An uplink receiving beamforming method will be described with reference to the figures.

When the downlink transmission beamforming operation is performed and the problems in obtaining the CSIT are ignored, the adaptive beamforming algorithm has excellent characteristics. However, when the SDMA is applied, the beam formed by applying the adaptive beamforming algorithm transmits power in various directions, and therefore considerable interference occurs for users receiving the same frequency resources. Accordingly, the switched BF algorithm is applied in the transmission beamforming process. However, since the power is not transmitted in the receiving beamforming process and it is not required to consider the interference, the adaptive beamforming method having excellent performance is selected.

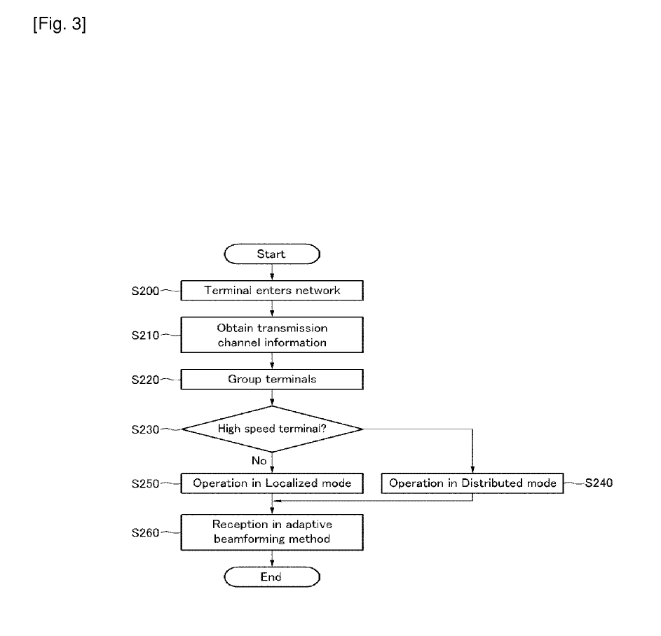

FIG. 3 is a flowchart representing the uplink receiving BF method of the base station after the terminal enters the network in the exemplary embodiment of the present invention, and particularly representing the uplink receiving BF method in a frequency division duplex (FDD) wireless communication system.

Channel information is required to perform the beamforming operation. There is no problem in measuring the channel information in a case of the receiving beamforming of the base station, but channel status information at receiver (CSIR) may not be measured since the terminal does not always transmit the training signal and the base station does not always measure the CSIR.

In addition, in a time division duplex (TDD) transmission method, it is determined that transmitting channel information and receiving channel information are the same since the same frequencies are used in the transmitting channel information and receiving channel information. Accordingly, the CSIR may be used for the CSIT in the TDD transmission method.

However, in the FDD transmission method, the CSIT may not be used for the CSIR since the same channels are used for the transmitting/receiving channels. Since the preferred switched beam index is included in the CSIT when the switched BF algorithm is applied to the transmission BF in the FDD system, the base station may detect a position of the terminal in a cell. Accordingly, the base station uses the CSIT measured by the terminal when the downlink receiving beamforming is performed. The downlink receiving beamforming method according to the exemplary embodiment of the present invention will now be described.

Referring to FIG. 3, the terminal enters a network in step S300, the base station receives the CSIT measured by the terminal to perform the downlink beamforming in step S310, and the base station uses the preferred switched beam index included in the CSIT to detect the position of the terminal in the cell. Since the fixed switched beams are designed to divide space, the different preferred switched beam indexes indicate different spaces. Accordingly, when two terminals report respective preferred switched beam indexes, the two terminals are separately positioned in two different spaces.

In addition, the base station obtaining the CSIT performs a terminal grouping operation for each channel characteristic without additionally obtaining the uplink CSIR in step S220. Terminal group information is used to realize the SDMA for simultaneously allocating the same radio resources to the mobile terminals positioned in the separated spaces by the base station. As described, the CSIT is applied to the uplink receiving SDMA in the FDD and TDD transmission methods.

In addition, when the terminal grouping operation is performed in the TDD system, it is determined in step S230 whether a corresponding terminal is a high speed mobile terminal or a low speed mobile terminal, the base station operates in the distributed mode in step S240 when the terminal is the high speed mobile terminal, and the base station operates in the localized mode in step S250 when the terminal is the low speed mobile terminal. The same resource is repeatedly allocated to the two terminals positioned in the different spaces by using the terminal grouping information, and therefore the MUD gain may be obtained.

After allocating the resources, the signals transmitted for each element based on the CSIT are received from the terminal by applying the adaptive beamforming algorithm in step S260. In the adaptive beamforming method, the signals transmitted for each receiving antenna element are combined based on a predetermined standard. A minimum mean square error (MMSE) is used as the standard when the SDMA is applied, and maximum ratio combining (MRC) is used as the standard when the SDMA is not applied.

Table 2 shows states of the SDMA, band selection scheduling operation, and uplink receiving beamforming method according to the speed of the terminal.

TABLE 2

| | Low speed terminal | High speed terminal |
|---|---|---|
| After terminal enters network | Terminal transmission: No BF | Terminal transmission: No BF |
| (base station has CIST) | Base station reception: | Base station reception: Adaptive |
| | Adaptive BF | BF |
| | SDMA application: MMSE | SDMA application: MMSE |
| | SDMA non-application: MRC | SDMA non-application: MRC |
| | Subcarrier allocating method | Subcarrier allocating method |
| | SDMA application: Localized | SDMA application: Distributed |
| | or Distributed | SDMA non-application: |
| | SDMA non-application: | Distributed |
| | Localized | |

| | |
|---|---|
| Before terminal enters network | Terminal transmission: No BF |
| (base station has no CIST) | Base station reception: Blind BF |
| | Subcarrier allocating method: Distributed |

As shown in Table 2, the blind beamforming is applied before the terminal enters the network. The blind beamforming method will be described.

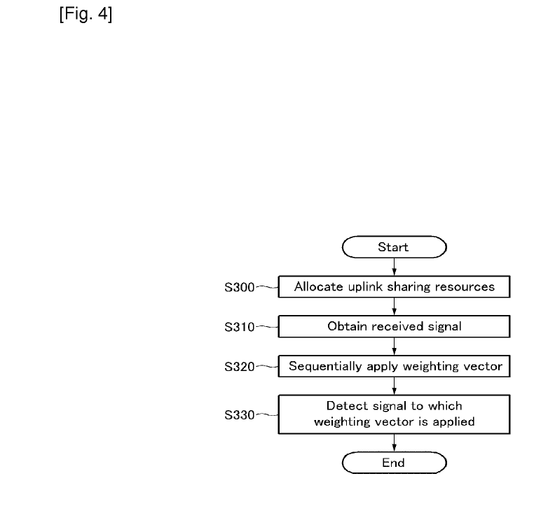

FIG. 4 is a flowchart representing an uplink receiving blind beamforming process according to the exemplary embodiment of the present invention. In the uplink receiving blind beamforming process, the base station performing the beamforming operation detects a packet transmitted by random access when the terminal tries to enter the network.

Firstly, the base station allocates uplink sharing resources that are allowed to be collided in step S300 so that the terminal that does not enter the network transmits the packet when the terminal accesses the network.

Subsequently, the terminal transmits the packet by using the allocated uplink sharing resources, and the base station obtains and stores the packet in step S310.

Subsequently, each weighting vector is sequentially applied to the obtained signals in step S320, and the signals are independently detected for each weight value in step S330.

In this blind BF method corresponding to the fixed beamforming (switched BF), the receiving beamforming is performed while the base station has no channel information, and weighting vectors of the fixed receiving beamforming (switched BF) are sequentially applied. In this case, the weighting vector applied when the downlink transmission beamforming is performed may be used.

A collision solving process for the simultaneously transmitted signals is performed to increase receiving performance when the packet transmission method is the TDMA method in the detection process, and a process for reducing interference power between signals and increasing receiving probability when the packet transmission method is a code division multiple access (CDMA) method. The collision solving process and the interference power reducing process have been disclosed, and are well known to a person of ordinary skill in the art.

For example, in the TDMA method, when two users perform the transmission in the random access by using the same resources, the detection may be successfully performed by sequentially applying the fixed beamforming when the two users are separately positioned. In addition, in the code division multiple access (CDMA) method, when various users perform the transmission by using the same resources, CDMA detection success probability may be improved since the blind beamforming may reduce the interference.

As described, the base station allocates the uplink sharing resources that may be allowed to be collided to the terminal before the terminal enters the network, and the terminal uses the resources to perform the packet transmission for the random access.

In this case, it is required to further perform the collision solving process in the detection process when the random access is performed in the TDMA method, and the SDMA effect may be obtained since the collision is solved when the users are separately positioned in different spaces. In addition, in the CDMA method, the interference power is reduced, the receiving quality may be improved, and more users may be included.

Further, when the switched BF algorithm for forming a directional beam is selected as the transmission BF method, the amount of required CSIT information is reduced, and the interference may be reduced when the SDMA is applied in a multi-user environment. Still further, when the array antenna of half wavelength intervals is used, the performance may not be steeply deteriorated when the updating period of the preferred switched beam index is increased since the width of beam is wide. The band selection scheduling is selectively performed according to the speed of the mobile terminal, and therefore the MUD gain may be obtained in the multi-user environment.

In the uplink receiving beamforming, since the CSIT obtained for the transmission beamforming is used rather than using the CSIR to realize the SDMA, it is not required to perform an additional CSIR obtaining process. In the TDD method, the reversible channel characteristics are used to improve the performance by the MUD gain obtained by the band selection in the uplink receiving beamforming.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, in the downlink transmission beamforming, the SDMA and MUD gains may be simultaneously obtained by using the switched BF algorithm and the half wavelength array and selectively performing the band selection scheduling according to the speed of the mobile terminal.

In the uplink receiving beamforming, since the CSIT obtained for the transmission beamforming is used rather than using the CSIR to realize the SDMA, it is not required to perform an additional CSIR obtaining process. In the TDD method, the reversible channel characteristics are used to improve the performance by the MUD gain obtained by the band selection in the uplink receiving beamforming.

Further, in the above method for detecting the packet transmitted by the terminal before entering the network, the receiving performance at the base station may be increased, and therefore detection performance may be increased.

1. A beamforming device for detecting a packet transmitted by terminal before entering a network to enter the network, the beamforming device comprising:
at least one receiving antenna for receiving a signal from the terminal;
a data acquisition unit for obtaining and outputting the signal received through the at least one receiving antenna;
a weighting vector applying unit for applying at least one weighing vector to the received signal and outputting the signal; and
a detection unit for detecting the signal output from the weighting vector applying unit for each the weighting vector.

2. The beamforming device of claim 1, wherein the received signal is received by using sharing resources that are allowed to be collided.

3. The beamforming device of claim 1, wherein the at least one weighting vector is corresponding to a switched beamforming (BF) algorithm.

4. The beamforming device of claim 3, wherein the at least one weighting vector is a weighting vector applied when a downlink transmission beamforming operation is performed.

5. A beamforming method of a base station to detect packets transmitted by a plurality of terminals to enter a network, the beamforming method comprising:
receiving a signal including packets transmitted from the terminals; and
detecting the respective packets one-by-one by sequentially applying weighting vectors belonging to the base station.

6. The beamforming method of claim 5, further comprising allocating sharing resources in which the transmitted packets from the terminals are allowed to be collided.

7. The beamforming method of claim 6, further comprising solving collision caused by the plurality of the transmitted packets from the plurality of terminals.

8. The beamforming method of claim 6, further comprising reducing interference caused by the plurality of the transmitted packets from the plurality of terminals.

9. An uplink receiving beamforming method of a base station in a frequency division duplex (FDD) wireless communication system, the uplink receiving beamforming method comprising:
receiving transmission channel information measured by a terminal;
grouping the terminal according to a preferred switched beam index included in the transmission channel information;
realizing spatial division multiple access corresponding to the terminal grouped; and
obtaining a signal received from the terminal according to the spatial division multiple access through an adaptive beamforming algorithm.

10. The uplink receiving beamforming method of claim 9, further comprising, allocating uplink resources by using the preferred band index included in the transmission channel information,
wherein the obtaining of the signal comprises receiving the signal from the terminal by using the allocated uplink resources.

11. The uplink receiving beamforming method of claim 10, wherein the obtaining of the signal comprises receiving the signal from the terminal by using a half wavelength array antenna.

12. The uplink receiving beamforming method of claim 9, wherein the transmission channel information is transmission channel information received to realize downlink transmission beamforming of the base station.

13. The uplink receiving beamforming method of claim 12, wherein the preferred switched beam index is information corresponding to downlink transmission beamforming realization to which a switched beamforming algorithm is applied.
